(19) United States
(12) Patent Application Publication
(10) Pub. No.: US 2006/0280108 A1
(43) Pub. Date: Dec. 14, 2006

(54) Optical disc

(75) Inventor: Taku Hoshizawa, Kawasaki (JP)

Correspondence Address: MCDERMOTT WILL & EMERY LLP, 600 13TH STREET, N.W., WASHINGTON, DC, 20005-3096, US

(73) Assignee: HITACHI, LTD.

(21) Appl. No.: 11/362,187

(22) Filed: Feb. 27, 2006

(30) Foreign Application Priority Data
Jun. 10, 2005 (JP) 2005-170299

(51) Int. Cl. G11B 7/24

(52) U.S. Cl. 369/275.3

(57) ABSTRACT

The invention has an object to reduce the time required for setting of a circuit for reproduction in use of the PRML system, thereby shortening the time until the readout of an optical disc becomes possible after mounting the disc. The invention will achieve the above-mentioned object with the following arrangement. An optical disc of the invention includes a lead-in area and a data area. The lead-in area includes a recorded area in which information is previously recorded, and a recordable area. The recorded area of the lead-in area includes a plurality of recording parameters for use in recording data in the data area, and reproduction parameters corresponding to the plurality of recording parameters.

### BACKGROUND OF THE INVENTION

1. Field of the Invention

The present invention relates to an optical disc and an optical disc apparatus therefor.

2. Description of the Related Art

Conventionally, as optical discs, a compact disc (CD), a digital versatile disc (DVD), and the like have been used widely. In such widely used optical discs, data is reproduced by binarizing a reproduced signal, and determining the presence or absence of pits by an appropriate slice. If the reproduced signal does not have some degree of amplitude in the shortest pit, the reliability of reproduced data cannot be ensured sufficiently. Recently, as a technology for achieving an optical disk with more recording density, a detection method of reproduced signals, which is called Partial-Response Maximum-Likelihood (PRML), has been introduced. The PRML is characterized in that the reproduced signals are converted into multilevel signals, which is called a partial response equalization, instead of into the simple binary signals. JP-A No. 327013/2004 discloses that the use of the PRML can provide good performance even in the pit length that is smaller than that in the prior art.

Furthermore, a detailed description of the PRML regarding an exemplary circuit structure is disclosed in JP-A No. 178627/2004.

### SUMMARY OF THE INVENTION

Compared with the conventional binarization by the slice, the PRML system has too many parameters which must be set for a circuit, and thus the adjustment of the parameters after mounting the optical disc is time-consuming. That is, a time from when the disc is inserted to when the readout of the disc becomes possible in the PRML system is longer than that in the binarization system.

It is an object of the invention to reduce the time required for setting of the circuit for reproduction or playback in use of the PRML system, thereby shortening the time until the readout of the optical disc becomes possible after mounting the optical disc.

The invention will solve the above-mentioned problem with the following arrangement.

An optical disc according to one aspect of the invention comprises a lead-in area and a data area. The lead-in area includes a recorded area in which information is previously recorded, and a recordable area. The recorded area of the lead-in area includes a plurality of recording parameters for use in recording data in the data area, and reproduction parameters corresponding to the plurality of recording parameters.

### BRIEF DESCRIPTION OF THE DRAWINGS

Fig. 1 shows some types of data recorded in a lead-in area of an optical disc;

FIG. 2 shows a relationship between an address space and the area of the optical disc;

FIG. 3 is a diagram of the configuration of an optical disc apparatus;

FIG. 4 is a diagram of the configuration of an equalization circuit;

FIG. 5 is a diagram of the configuration of a viterbi decoder;

FIG. 6 is a diagram of the configuration of a branch metric arithmetic circuit;

FIG. 7 shows a relationship between a recorded waveform and parameters of the recorded waveform;

FIG. 8 shows some types of data previously recorded in the lead-in area of a recording type optical disc;

FIG. 9 shows some types of data to be recorded in the lead-in area of the recording type optical disc; and

FIG. 10 is a diagram showing an apparatus for manufacturing the optical disc.

### DETAILED DESCRIPTION OF THE PREFERRED EMBODIMENTS

Preferred embodiments of the present invention will now be described in detail with reference to the accompanying drawings, which include a lead-in area 201, a data area 202, a lead-out area 203, an optical disc 301, a pickup 302, an analog/digital conversion circuit (A/D) 303, an equalization circuit 304, a viterbi decoder 305, a servo circuit 306, a system control circuit 307, and a laser driver (LD) 308.

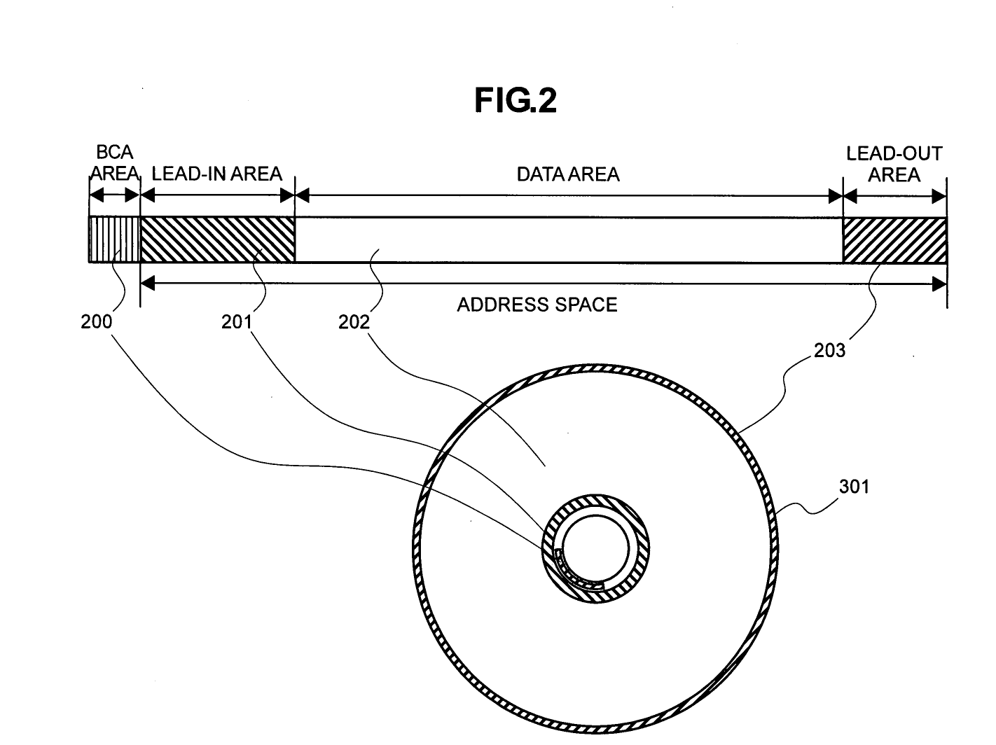

FIG. 2 shows the relationship between an address space of the optical disc 301 and areas according to the embodiment. As shown in the figure, the disc 301 includes a BCA area 200, the lead-in area 201, the data area 202, and the lead-out area 203.

The BCA area 200 and the lead-in area 201 are positioned at the inner radius of the optical disc, which mainly records therein management information about a recorded area, defect management information, and disc control information including a write strategy. The data area 202 is related to a logical address, and data is recorded in or reproduced from the data area 202 based on a command from the host. The lead-out area 203 is positioned at the outer radius of the optical disc, and part of the data in the lead-in area is copied and recorded in the lead-out area 203. Although in the figure, the BCA area and the lead-in area are disposed at the inner radius of the disc, and the lead-out area is disposed at the outer radius thereof as mentioned above, the invention is not limited thereto.

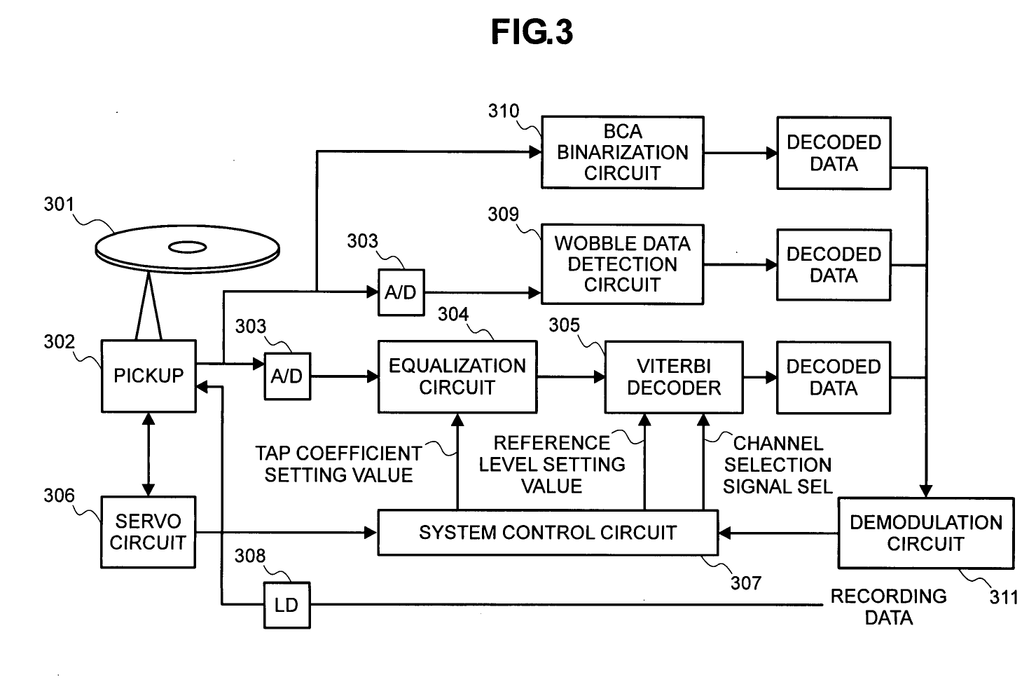

FIG. 3 shows the configuration of an optical disc apparatus according to the embodiment. As shown in the figure, the optical disc apparatus includes the optical disc 301, the pickup 302, the analog/digital conversion circuit (A/D) 303, the equalization circuit 304, the viterbi decoder 305, the servo circuit 306, the system control circuit 307, the laser driver (LD) 308, a wobble data detection circuit 309, a BCA binarization circuit 310, and a demodulation circuit 311.

In reproducing the optical disc, the pickup 302 irradiates the optical disc 301 with a laser light, and detects an amount or deflection of the reflected light from the optical disc to reproduce data recorded on the optical disc. At this time, the servo circuit 306 causes the pickup 302 to accurately follow the disc in a focus direction and in a track direction. The reproduced signal read by the optical pickup 302 is digitalized by the A/D 303, equalized by the equalization circuit 304, and binarized by the viterbi decoder 305.

The system control circuit 307 collects information about the types of discs, for example, via the servo circuit 306, and detects which playback channel or modulation code is used in the disc.

The system control circuit 307 sets an appropriate tap coefficient for the equalization circuit 304 so as to obtain channel characteristics corresponding to each medium. Furthermore, the system control circuit 307 sets for the viterbi decoder 305, a channel selection signal SEL and a reference level corresponding to the channel characteristics set for the equalization circuit 304. The viterbi decoder 305 receives the reference level value and the channel selection signal SEL to change a connection state of the circuit system to perform viterbi decoding. Thus, the channel characteristics are changed according to the disc, thereby enabling reproduction of the information in the optimum condition.

It should be noted that the decoded data which is information in the BCA area 200 detected by the BCA binarization circuit 310, and the decoded data which is information in the lead-in area 201 detected by the wobble data detection circuit 309 may be fed back to the system control circuit 307 to control the equalization circuit 304 and the viterbi decoder 305.

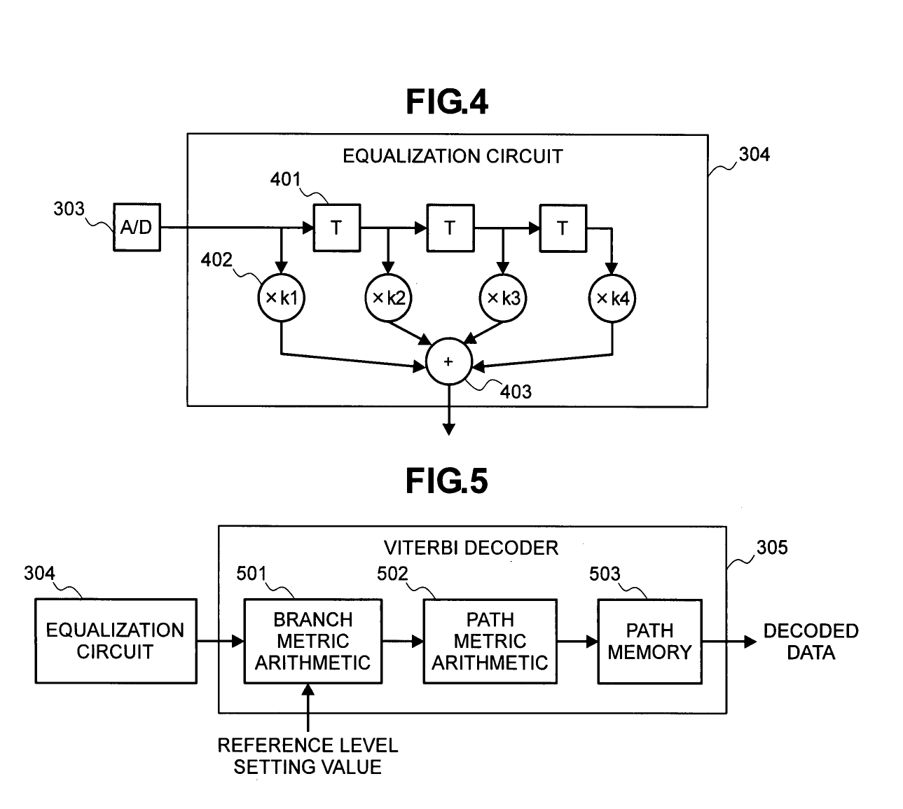

Referring to FIG. 4, the configuration of the equalization circuit 304 will be described below in detail. In the figure, the equalization circuit 304 includes a delay circuit 401 normally constituted of a register, a multiplication circuit 402, and an addition circuit 403. Sample data with multilevels output from the A/D 303 is shift-input into the delay circuit 401 in succession. An output signal from the A/D 303 and an output from the delay circuit 401 are multiplied by the respective coefficients, and are added to each other so as to be output to the outside of the equalization circuit. The tap coefficient used for multiplication of each output at this time is a value for aligning the sample data on the playback waveform with the reference value of the viterbi decoder, and for correcting a distortion included in the waveform of the reproduced signal. Therefore, since the tap coefficient is influenced by the shapes of pits, mirrors, marks, or spaces actually formed on the optical disc, or a width or depth of recordng grooves on the disc, the system control circuit 307 needs to set the appropriate value for each optical disk as the tap coefficient.

Next, referring to FIG. 5, the configuration of the viterbi decoder 305 will be described below in detail. In the figure, the viterbi decoder includes a branch metric arithmetic circuit 501, a path metric arithmetic circuit 502, and a path memory 503. The branch metric arithmetic circuit 501 calculates a squared error between the sample data of the reproduced signal waveform from the equalization circuit 304 and the reference value set by the system control circuit 307 to output a branch metric. The path metric arithmetic circuit 502 accumulates and adds the branch metrics for each pattern to obtain the path metric. The path memory stores therein a plurality of data series, and selects and outputs the data series with the minimum path metric, that is, the most reliable path.

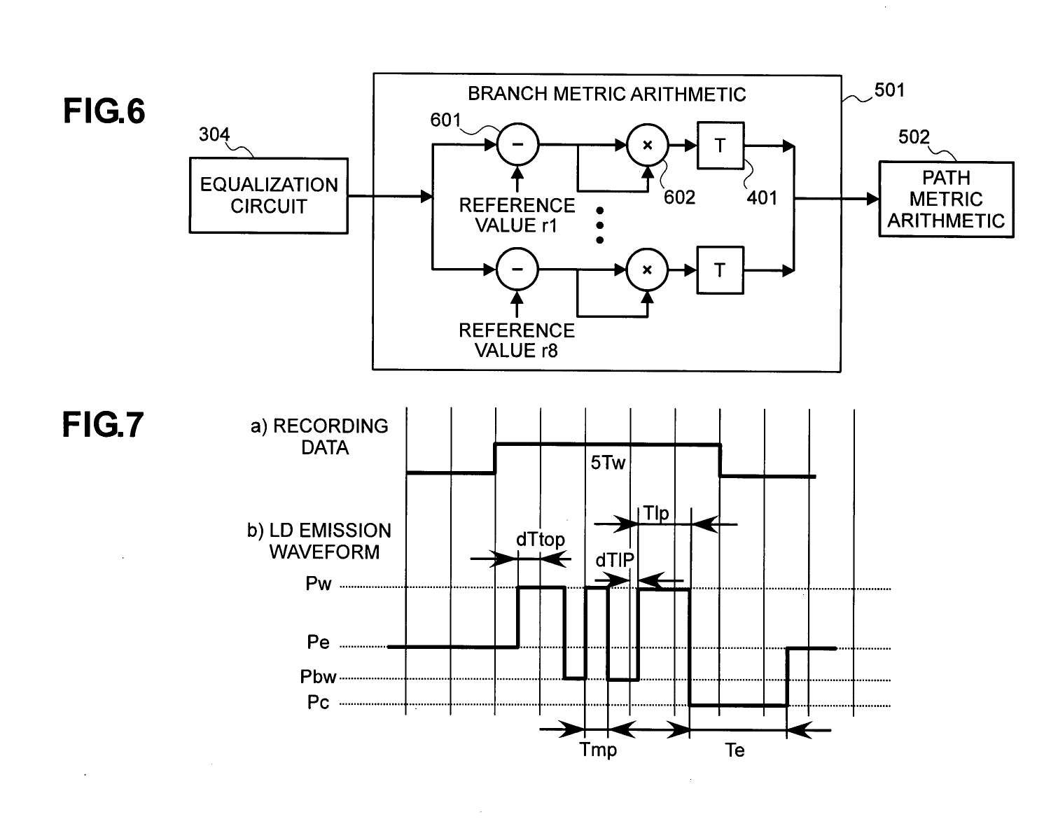

Referring now to FIG. 6, the branch metric arithmetic circuit 501 will be described below in detail. As shown in the figure, the branch metric arithmetic circuit includes a subtraction circuit 601, a multiplication (sequence) circuit 602, and a delay circuit 401. As mentioned above, the branch metric arithmetic circuit 501 subtracts the reference value set by the system control circuit 307 from the sample data on the reproduced signal waveform, and calculates a squared error in the thus-obtained difference to output it as the branch metric. That is, in the branch metric arithmetic circuit 501, the reference value set by the system control circuit 307 is used for correcting a distortion included in the waveform of the reproduced signal, as is the case with the tap coefficient in FIG. 4.

In recording on the recording type optical disc, the recording data modulated is recorded on the optical disc 301 by irradiating the disc with the laser light from the pickup by a laser driver in response to the value of the recording parameter (write strategy) previously set by the system control circuit.

FIG. 7 shows the relationship among the recording data, the recording waveform and the recording parameters of the light emitted from the LD 308. The recording waveform defined by the recording parameters is also called write strategy. FIG. 7A shows the recording data, and FIG. 7B shows a LD emission waveform. In the figures, the emission waveform is shown in which a mark with the length of 5 Tw (Tw indicating a channel bit) is recorded at three kinds of pulses, namely, a top pulse, an intermediate pulse, and a last pulse. The parameters for defining the emission strength of the emission waveform of the embodiment include a writing power Pw, an erasing power Pe, a bottom power Pbw, and a cooling power Pc. The parameters for use in defining the time of emission includes a deviation from the reference time of the top pulse dTtop, a deviation from the reference time of the intermediate pulse dTmp, a deviation from the reference time of the last pulse dTlp, a length of the last pulse Tlp, and a length of the cooling pulse Te. As mentioned above, each pulse is defined by the emission power, the deviation from the reference position, and the length of the pulse in principle. Although in FIG. 7B, the deviation of the intermediate pulse from the reference value is zero, and the cooling pulse is started at a trailing edge of the last pulse, the invention is not limited thereto. The recording waveform used in FIG. 7 is called as the write strategy of the multi-pulses, but the recording waveforms may include various other kinds of write strategies, such as a non-multi-pulse write strategy which has no bottom power Pbw. In general, even in one optical disc, a plurality of kinds of write strategies are defined and used according to a recording speed.

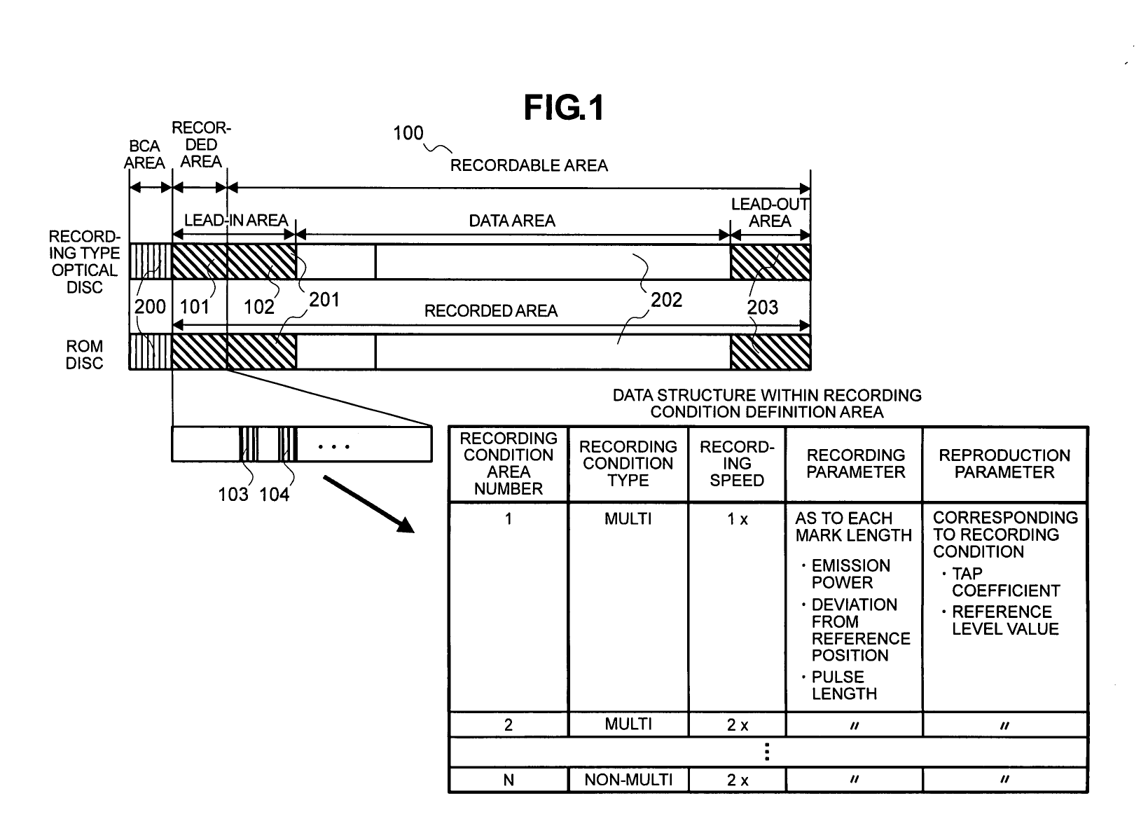

Now, the optical disc of the embodiment will be described in detail with reference to FIG. 1. In the figure, the upper diagram explains the recording type optical disc, and the lower diagram explains a ROM disc.

The recording type optical disc is constituted of the BCA area 200 in which identification information or the like is recorded, the lead-in area 201, the data area 202, and the lead-out area 203. The lead-in area 201 further includes a recorded area 101 in which the information is previously recorded and additional user data is not recordable, and a recordable area 102 in which additional user data is recordable. That is, in the BCA area 200 and the recorded area 101, additional user data cannot be written, whereas in the recordable area 102 of the lead-in area, the data area 202, and the lead-out area 203, additional user data can be written. The information in the BCA area 200 is recorded by a bar code, which is formed by, for example, YAG laser or the like. The information in the recorded area 101 is recorded in the form of, for example, square wave-like grooves. The square wave-like grooves are formed by, for example a stamper, in manufacturing the disc, and include square wave-like pits and projections which are formed by, for example, a high-frequency module. The recordable area 100 has wobble grooves on its track side, in which address information or the like is recorded.

In contrast, the ROM disc is constituted of the BCA area 200, the lead-in area 201, the data area 202, and the lead-out area 203. Since in any one of the areas, additional user data cannot be written, the lead-in area 201, the data area 202, and the lead-out area 203 all belong to the recorded area 100.

In either of the discs, in the data area 202, data is recorded at high density, and in the recorded area 101, a recording condition definition area 103 corresponding to the first recording condition, and a recording condition definition area 104 corresponding to the second recording condition are previously recorded. In each recording condition definition area, various kinds of information corresponding to each recording condition are recorded. The information includes a recording condition area number, a recording condition type, a recording speed, a recording parameter, and a reproduction or playback parameter. It is apparent that although in the embodiment, two recording condition definition areas are described, the number of the recording condition definition areas is not limited thereto, and may be increased appropriately according to the recording condition type. In FIG. 1, a continuous integer number is attached as the recording condition area number, but the recording condition area number is not limited thereto if it is distinguishable. The recording condition type indicates whether the recording condition is a multi-pulse write strategy or anon-multi-pulse write strategy. The recording speed is a write speed in which the data is recorded or written. The recording parameters indicate the emission power, the deviation from the reference position, and the pulse length which are set for the mark length. The reproduction parameters indicate parameters set in the reproduction process circuit when the data area recorded is reproduced using the respective recording parameters. As the reproduction parameters, are recorded a recommended tap coefficient in the equalization circuit, and a recommended reference level value of the viterbi decoder. The recommended tap coefficient is a value used in the multiplication circuit 402 of the equalization circuit 304 so as to reduce the error frequency in the binarization process performed by the viterbi decoder 305 in reproducing the optical disc. The recommended reference level value is a value used in the branch metric arithmetic circuit 501 of the viterbi decoder 305. The optical disc apparatus can perform the excellent and quick data reproduction process of the data recorded in the data area 202 at high density by reading out the recommended values from the disc upon mounting the disc, and by setting these values as the reproduction parameters for the process circuit of the reproduction signal waveform.

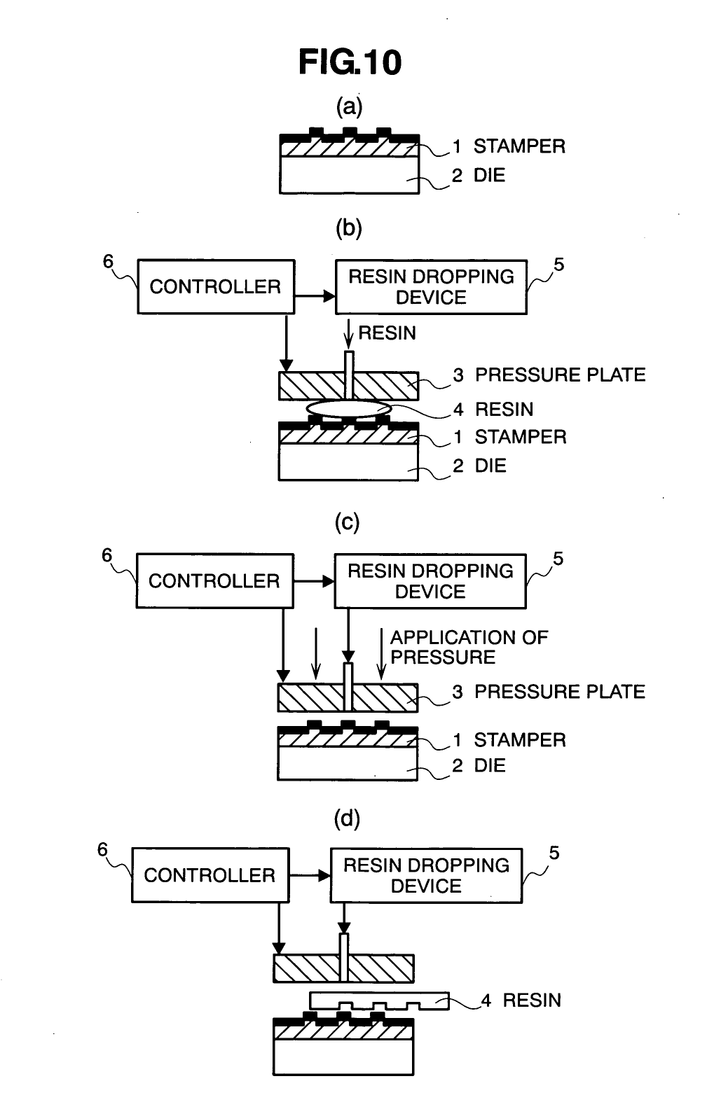

When manufacturing the optical disc illustrated in FIG. 1, an apparatus such as that shown in FIG. 10 is used. In FIG. 10, the apparatus includes a stamper 1 on which the square wave-like or wobble grooves are formed, a die 2, a pressure plate 3, a resin 4, a resin dropping device 5, and a controller 6. First, as shown in FIG. 10A, the stamper 1 is disposed on the die 2. Then, the controller 6 controls the resin dropping device 5 to drop resin 4 into between the pressure plate 3 and the stamper 1 as shown in FIG. 10B. Furthermore, the controller 6 controls the pressure plate 3 to apply a certain pressure as shown in FIG. 10C, and then stops the application of pressure after a predetermined elapsed time. Last, a substrate is removed, thereby finishing the manufacturing of the optical disc, as shown in FIG. 10d. FIG. 10 shows an example in which the square wave-like or wobble grooves are formed on the optical disc; however, the invention is not limited thereto.

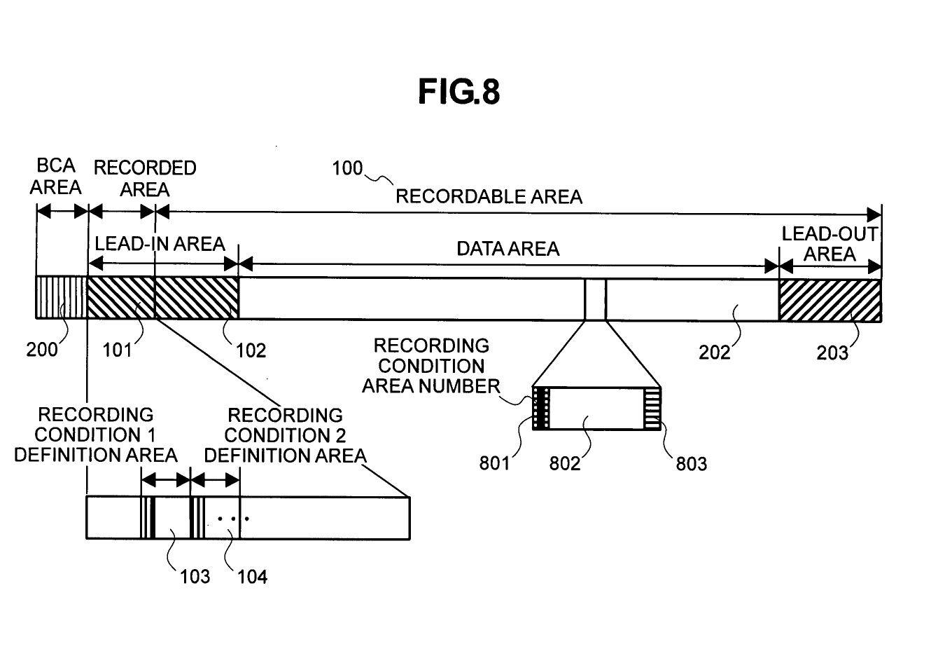

Referring to FIG. 8, a recording type optical disc according to another embodiment of the invention will now be described in detail. In FIG. 8, identical or equivalent parts are denoted with the same reference numerals as in FIG. 1, and thus an explanation thereof will be omitted.

In the data area 202, user data 802 is recorded by the optical disc apparatus of the invention. When the user data 802 is recorded, redundant data including a run-in 801 and a run-out 803 is added and recorded in the area. In the run-in 801, the recording condition area number is recorded corresponding to the recording condition used when the user data 802 is recorded. In the data area 202, a plurality of kinds of user data 802 can be recorded, and each user data 802 is recorded using one kind of the recording condition. In recording a plurality of kinds of user data 802, the same or different recording conditions may be used.

The reproduction process of the optical disc will be briefly described below. Even in cases where the same mark is intended to be recorded on the same optical disc, if the recording speeds or recording waveforms for use are different, different marks with different physical shapes are recorded on the disc. That is, the reproduction parameter corresponding to the recording condition used in recording of data can be set for the reproduction process circuit, thereby achieving the excellent reproduction process.

Since the reproduction parameter corresponding to the recording condition is recorded in the lead-in area 101 of the optical disc according to the invention, the optical disc apparatus can know the reproduction parameter corresponding to the recording condition area number obtained from the run-in 801, from the recording condition definition area of the lead-in area 101. Therefore, the appropriate reproduction parameter can be set quickly for the reproduction process circuit, thereby achieving the quick and suitable reproduction process. Only the recording condition area number is recorded in the run-in 801, so that the data area can be effectively used. The optical disc apparatus is configured such that the corresponding reproduction parameter is read from the recording condition definition area after reproducing the recording condition area number of the run-in 801. Alternatively, the optical disc apparatus may be configured such that all the recording condition definition areas are read out after mounting the disc, and the respective reproduction parameters are stored in a memory, whereby the corresponding reproduction parameter may be read out from the memory or the like after reproducing the recording condition area number in the run-in 801. This can know the appropriate reproduction parameter at high speed without obtaining the appropriate value of the reproduction parameter by a learning process, thereby enabling the excellent data reproduction process.

It should be noted that although in the examples above, the recording condition area number is recorded in the run-in 801, the reproduction parameter corresponding to the recording condition used in recording of the user data 802 may be directly recorded in the run-in 801. In this case, the appropriate reproduction parameter can be understood quickly by reading out the reproduction parameter from the run-in 801, without needing reading the reproduction parameter from the recording condition definition area of the lead-in area 101, thereby performing the excellent data reproduction process. This also eliminates the necessity of recording the data for the recording condition definition area in the recorded area 101. When recording the recording condition area number and the reproduction parameter in the run-in 801, a plurality of the same information pieces may be recorded, or the information may be recorded at low density in the run-in 801. This has an advantage in that the information in the run-in 801 is read out accurately.

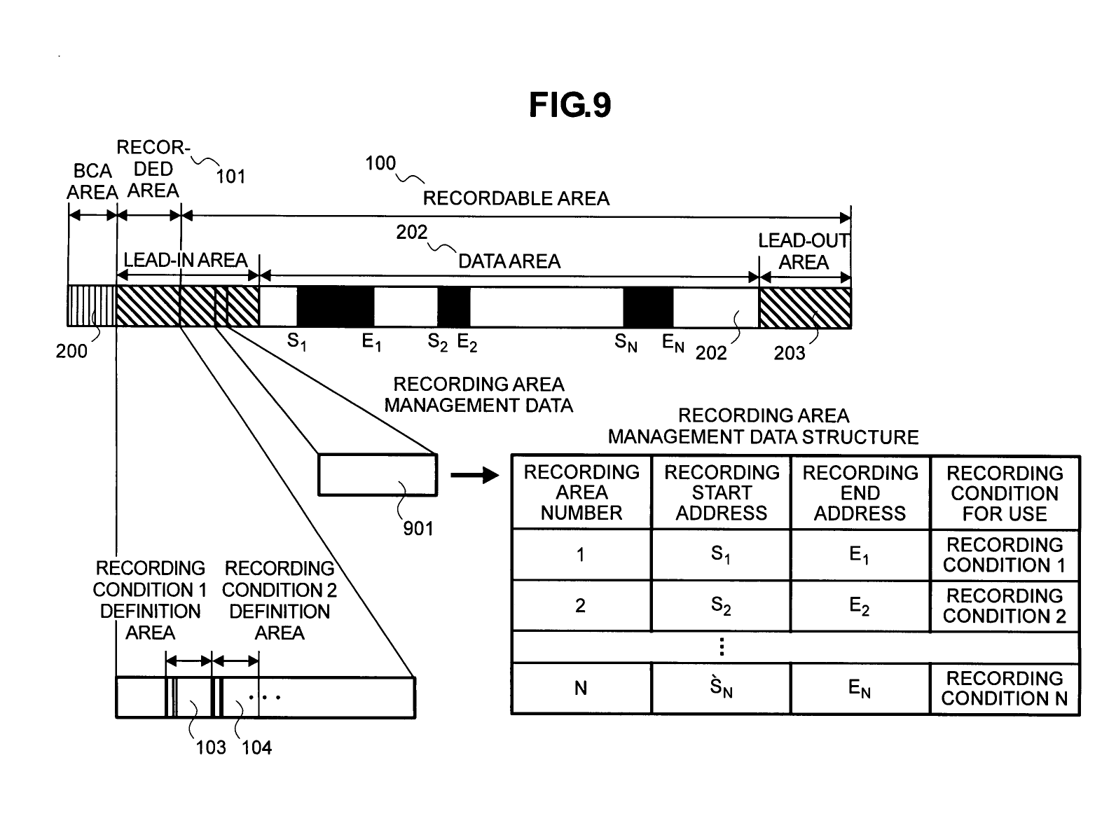

FIG. 9 shows another example of a recording type optical disc according to the embodiment. In the recorded area, there exist a plurality of recording condition definition areas, as is the case with in the recorded areas of FIGS. 1 and 8. In FIG. 9, identical or equivalent parts are denoted with the same reference numerals as in FIG. 1, and an explanation thereof will be omitted. In the figure, black parts S₁ to E₁, S₂ to E₂, and S_{N} to E_{N} within the data area 202 indicate recording areas 1, 2, and N, respectively, in which the data is recorded by the optical disc apparatus of the embodiment. In the recordable area 102 of the lead-in area, recording area management data 901 is recorded by the optical disc apparatus of the embodiment.

The recording area management data 901 manages the recording area numbers, the recording start addresses, the recording end addresses, and the recording condition for use, as a set in a list. Concretely, the list is displayed which includes the recording area number 1 corresponding to the recording area 1, and a recording start address S₁, a recording end address E₁, and a used recording condition 1 which correspond to the recording area number 1. As to the recording area 2, and the recording area N, the similar lists are recorded.

In the optical disc apparatus of the embodiment, the recording condition used for recording in the specific recording area can be identified from the recording area management data, and the appropriate reproduction parameter can be set by referring to the reproduction parameter of the recording condition definition area in the recorded area 101. This can perform the excellent reproduction process to any one of the recording areas.

Accordingly, the optical disc apparatus of the embodiment reads from the disk the recording condition and the reproduction parameter of the reproduced signal waveform processing circuit in mounting the disk or the like, and reproduces the recording area management data 901 recorded in the recordable area 102 of the lead-in area, thereby determining the reproduction parameter for the reproduced signal waveform process of each recordable area. This can know the appropriate reproduction parameter quickly without obtaining the appropriate value of the reproduction parameter by a learning process, thereby enabling the excellent data reproduction process.

It should be noted that in the recording area management data 901, the reproduction parameter appropriate for reproduction of the recording area may be directly recorded. In this case, the appropriate reproduction parameter can be understood quickly by reading out the reproduction parameter from the recording area management data 901, thereby performing the excellent data reproduction process, which eliminates the necessity of recording the data for the recording condition definition area in the recorded area 101. When recording the recording area management data and the reproduction parameter in the recordable area 102 of the lead-in area, a plurality of the same information pieces may be recorded, or the information may be recorded at low density. This has the advantage in that the information in the recordable area 102 of the lead-in area is read out efficiently and accurately.

As shown in FIGS. 1, 8, and 9, the recording condition definition areas are disposed in the recorded area 101, thereby enabling the quick and excellent data reproduction process, as mentioned above. This is because a complicated reproduction technology, such as the PRML technology, is not required to reproduce information corresponding to the square wave-like grooves in the recorded area 101, so that the information can be reproduced readily; however, the invention is not limited thereto. For example, the information for the recording condition definition area may be recorded in the BCA area 200, or in wobble grooves of the recordable area 100. This is because also when reproducing the information in the BCA area or wobble grooves, the complicated reproduction technology, such as the PRML technology, is not needed as is the case with the above-mentioned square wave-like grooves, so that the information can be reproduced readily.

It should be noted that when information for the recording condition definition area is recorded in the BCA area 200, or in the square wave-like grooves of the recorded area 101, or in the wobble grooves of the recordable area 100, only one kind of the information may be recorded instead of a plurality of kinds of information.

As mentioned above, the use of the technology according to the invention reduces a setup time required for adjustment of various parameters of the reproduced signal waveform circuit so as to accommodate changes in recording waveform (write strategy) used upon recording, in recording speed, and in recording density.

What is claimed is:

1. An optical disc comprising:
a lead-in area including a recorded area in which information is previously recorded, and a recordable area; and
a data area,
wherein
the recorded area of said lead-in area includes a plurality of recording parameters for use in recording data in the data area, and reproduction parameters corresponding to each of the plurality of recording parameters.

2. An optical disc comprising:
a lead-in area including a recorded area in which information is previously recorded, and a recordable area; and
a data area,
wherein
the recorded area of said lead-in area includes a plurality of recording parameters for use in recording data in the data area, and reproduction parameters corresponding to each of the plurality of recording parameters, and
wherein
the data area includes the data to which information indicative of the recording parameter used in recording of the data is added.

3. An optical disc comprising:
a lead-in area including a recorded area in which information is previously recorded, and a recordable area; and
a data area,
wherein
the recorded area of said lead-in area includes a plurality of recording parameters for use in recording data in the data area, and reproduction parameters corresponding to each of the plurality of recording parameters, and
wherein
the recordable area of the lead-in area includes information indicative of the recording parameter used in recording of the data.

4. An optical disc comprising:
a lead-in area including a recorded area in which information is previously recorded, and a recordable area; and
a data area,
wherein
the recorded area of said lead-in area includes a plurality of recording parameters for use in recording data in the data area, and reproduction parameters corresponding to each of the plurality of recording parameters, and
wherein
the recordable area of the lead-in area includes information indicative of the recording parameter used in the recording of the data, and a start address and an end address of the recorded data using the recording parameter.

5. An optical disc comprising a lead-in area, and a data area, wherein
the data area includes the data to which a tap coefficient of an equalization circuit and a reference level value of a viterbi decoder are added as reproduction parameters corresponding to recording parameters used in recording the data in said data area.

6. An optical disc comprising:
a BCA area in which information is previously recorded by a bar code;
a lead-in area including a recorded area with square wave-like grooves in which information is previously recorded, and a recordable area with wobble grooves; and
a data area,
wherein
a recording parameter for use in recording data in said data area, and a reproduction parameter corresponding to the recording parameter are included in said bar code, said square wave-like groove, or said wobble groove.

7. The optical disc according to any one of claims 1 to 4 and 6,
wherein
said reproduction parameters are the tap coefficient of the equalization circuit, and the reference level value of the viterbi decoder.
